(19) United States
(12) Patent Application Publication
(10) Pub. No.: US 2015/0035730 A1
(43) Pub. Date: Feb. 5, 2015

(54) OLED DISPLAY PANEL

(71) Applicant: Ye Xin Technology Consulting Co., Ltd., Hsinchu (TW)

(72) Inventors: CHUN-CHIEH HUANG, Hsinchu (TW); WEI-LI WANG, Hsinchu (TW); CHANG-TING LIN, Hsinchu (TW)

(73) Assignee: YE XIN TECHNOLOGY CONSULTING CO., LTD., Hsinchu (TW)

(21) Appl. No.: 13/974,057

(22) Filed: Aug. 23, 2013

(30) Foreign Application Priority Data
Aug. 5, 2013 (TW) 102127959

(51) Int. Cl. G09G 3/32

(52) U.S. Cl. CPC G09G 3/3208
USPC 345/76

(57) ABSTRACT

An OLED display panel includes a plurality of spaced first pixels and a plurality of spaced second pixels spaced from each other. Each of the first pixel and the second pixel includes a first sub-pixel, a second sub-pixel and a third sub-pixel. The first sub-pixel, the second sub-pixel and the third sub-pixel are parallel to and spaced from each other. The first pixels and the second pixels are arranged in alternate pattern in one row. Of one first pixel and adjacent two second pixels of one row, the first sub-pixel of the first pixel is aligned with the first sub-pixel of the one second pixel, and the third sub-pixel of the first pixel is aligned with the third sub-pixel of the other one second pixel.

### BACKGROUND

1. Technical Field

The present disclosure relates to an OLED (organic light emitting diode) display panel.

2. Description of Related Art

OLEDs (organic light emitting diodes) are in development for use in displays. An OLED display panel includes a plurality of pixels. Referring to FIG. 1, each pixel includes three sub-pixels composed of red, green, and blue colors, to generate a color image. For higher pixel density, the arrangement of the sub-pixels must be more compact, thereby increasing the burden of manufacturing the OLED display panel.

Therefore, an OLED display panel capable of overcoming the above described shortcomings is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a schematic view of a traditional OLED display panel.

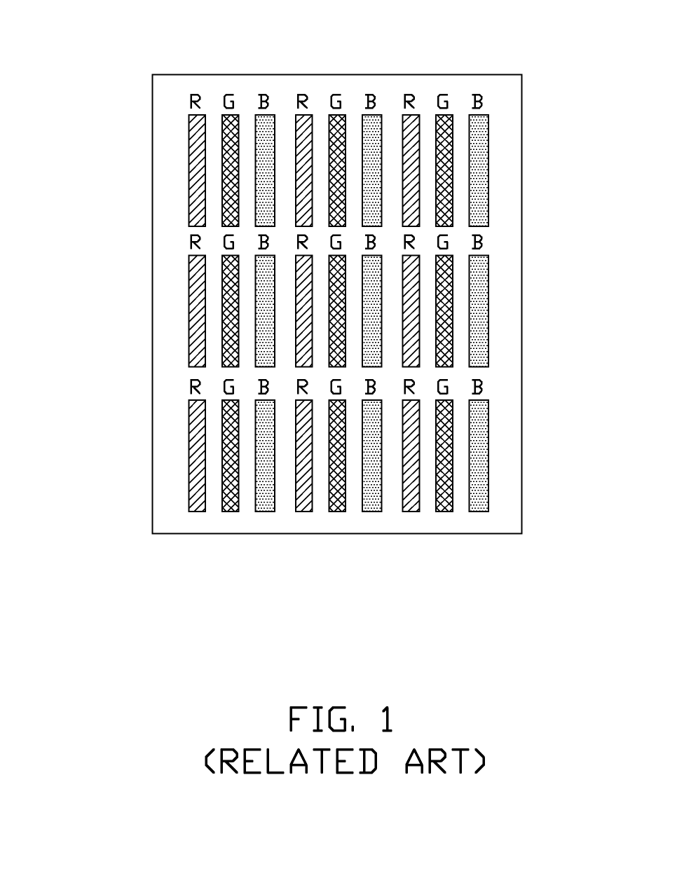

FIG. 2 shows a schematic view of an OLED display panel in accordance with an embodiment of the present disclosure.

### DETAILED DESCRIPTION

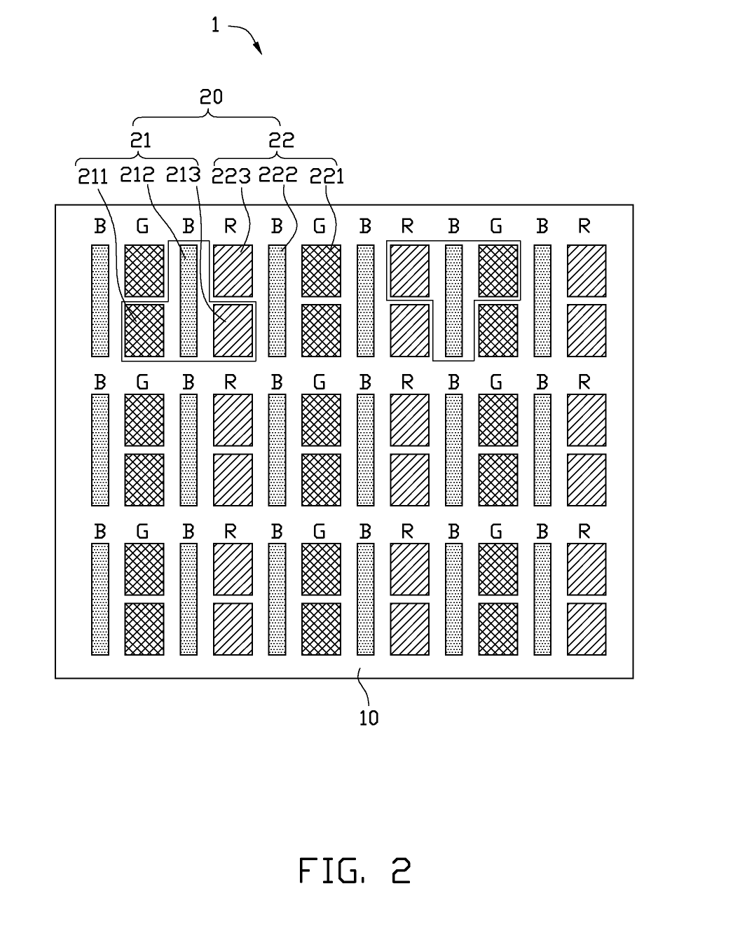

Referring to FIG. 2, an embodiment of an OLED display panel 1 includes a base 10 and a pixel array 20 formed on the base 10. The pixel array 20 includes a plurality of spaced first pixels 21 and a plurality of spaced second pixels 22.

The first pixels 21 and the second pixels 22 are arranged in alternate pattern in one row, and each of the first pixels 21 and the second pixels 22 are respectively arranged in a line.

Each of the first pixels 21 includes a first sub-pixel 211, a second sub-pixel 212, and a third sub-pixel 213 substantially parallel to and spaced from each other. The second sub-pixel 212 is located between the first sub-pixel 211 and the third sub-pixel 213. Bottom ends of the first sub-pixel 211 and the third sub-pixel 213 are substantially coplanar with a bottom end of the second sub-pixel 212. A length of the first sub-pixel 211 is equal to that of the third sub-pixel 213, and is less than that of the second sub-pixel 212.

Each of the second pixels 22 includes a first sub-pixel 221, a second sub-pixel 222, and a third sub-pixel 223 substantially parallel to and spaced from each other. The second sub-pixel 222 is located between the first sub-pixel 221 and the third sub-pixel 223. Top ends of the first sub-pixel 221 and the third sub-pixel 223 are substantially coplanar with a top end of the second sub-pixel 222. A length of the first sub-pixel 221 is equal to that of the third sub-pixel 223, and is less than that of the second sub-pixel 222.

In one row, the first sub-pixel 211 of the first pixel 21 is aligned with the first sub-pixel 221 of one second pixel 22, and the third sub-pixel 213 of the first pixel 21 is aligned with the third sub-pixel 223 of another second pixel 22.

In this embodiment, a length of the first sub-pixel 211 of each first pixel 21 is less than a half of that of the second sub-pixel 212, and a length of the first sub-pixel 221 of each second pixel 22 is less than a half of that of the second sub-pixel 222. The first sub-pixels 211, 221 of each first pixel 21 and each second pixel 22 are green sub-pixels, the second sub-pixels 212, 222 are blue sub-pixels, and the third sub-pixels 213, 223 are red sub-pixels. The first sub-pixels 211, 221, the second sub-pixels 212, 222 and the third sub-pixels 213, 223 are not limited to being a green sub-pixel, a blue sub-pixel, or a red sub-pixel, as long as they are a different color from each other.

For sub-pixels of the first pixel 21 aligned with the same color sub-pixels of the adjacent second pixel 22, the first pixel 21 and the adjacent second pixel 22 are closer.

Furthermore, the two first sub-pixels and the two third sub-pixels with the same color can be manufactured in one chamber by evaporation process. Thus, the width of the first sub-pixel and the third sub-pixel can be further decreased, and the resolution of the OLED display panel 1 is accordingly increased.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An organic light emitting diode (OLED) display panel, comprising a plurality of spaced first pixels and a plurality of spaced second pixels, wherein the first pixels are spaced from the second pixels; each of the first pixels comprising a first sub-pixel, a second sub-pixel, and a third sub-pixel; the first sub-pixel, the second sub-pixel, and the third sub-pixel of each first pixel being substantially parallel to and spaced from each other; each of the second pixels comprising a first sub-pixel, a second sub-pixel and a third sub-pixel; the first sub-pixel, the second sub-pixel and the third sub-pixel of each second pixel being substantially parallel to and spaced from each other; in the first pixel and the second pixel, the second sub-pixel is located between the first sub-pixel and the third sub-pixel, and lengths of the first sub-pixel and the third sub-pixel are less than that of the second sub-pixel; in the first pixel, bottom ends of the first sub-pixel and the third sub-pixel are substantially coplanar with a bottom end of the second sub-pixel; in the second pixel, top ends of the first sub-pixel and the third sub-pixel are substantially coplanar with a top end of the second sub-pixel; the first pixels and the second pixels are arranged in alternate pattern in one row; in one row, the first sub-pixel of the first pixel is aligned with the first sub-pixel of one second pixel, and the third sub-pixel of the first pixel is aligned with the third sub-pixel of another second pixel.

2. The OLED display panel of claim 1, wherein a length of the first sub-pixel of the first pixels and the second pixels is equal to that of the third sub-pixel of the first pixels and the second pixels.

3. The OLED display panel of claim 1, wherein a length of the first sub-pixel of the first pixels and the second pixels is less than a half of that of the second sub-pixel of the first pixels and the second pixels.

4. The OLED display panel of claim 1, wherein each of the first pixels and the second pixels are respectively arranged in a line.

5. The OLED display panel of claim 1, wherein the first sub-pixel of the first pixels and the second pixels is a green sub-pixel, the second sub-pixel of the first pixels and the second pixels is a blue sub-pixel, and the third sub-pixel of the first pixels and the second pixels is a red sub-pixel.
